(19) United States
(12) Patent Application Publication
(10) Pub. No.: US 2026/0172220 A1
(43) Pub. Date: Jun. 18, 2026

(54) ELECTRONIC CIRCUIT PROTECTED AGAINST ANALYSIS

(71) Applicant: IDEMIA FRANCE, Courbevoie (FR)

(72) Inventors: Samuel LESNE, Courbevoie (FR); Axel GUICHAOUA, Courbevoie (FR); Aita THIAW, Courbevoie (FR)

(73) Assignee: IDEMIA FRANCE, Courbevoie (FR)

(21) Appl. No.: 19/419,817

(22) Filed: Dec. 15, 2025

(30) Foreign Application Priority Data
Dec. 16, 2024 (FR) FR2414216

(51) Int. Cl. H04L 9/00; G06F 21/72; G06F 21/75

(52) U.S. Cl. CPC H04L 9/003; G06F 21/72; G06F 21/755

(57) ABSTRACT

An electronic circuit consisting of a plurality of logic gates where at least a portion of the plurality of logic gates is divided into a plurality of groups of logic gates, each group of logic gates is supplied with a voltage randomly selected from a set of at least two available voltages, and a new random selection of the voltages supplied to the groups of logic gates is made between two uses of the circuit.

The invention relates to the design of electronic circuits and their protection against attacks aimed at determining confidential information processed by the circuit by analysing the power consumption of the circuit.

Integrated electronic circuits consist of logic gates assembled in large numbers to form different parts of the circuit. These parts comprise function blocks responsible for performing computations on one or more inputs and producing one or more results, memories for storing these inputs and outputs, for example registers, random access memory, Muller gates, etc.

Each of the logic gates of which a circuit consists needs to be supplied with voltage. At all times, these logic gates consume electrical energy, which is supplied by their respective power supplies. This consumption is not constant and depends on the state of the gate, that is to say on the value of the input signals for the logic gate and on the resulting value produced at the output of the logic gate. During operation of the circuit, which is clocked by the clock signals that drive the circuit, new input values are applied to the input of the logic gates. After a time called the transition period, the gate stabilizes in a new state that depends on its inputs, to produce a stable output signal that can be used as the input for another logic gate. The power consumption of the gate changes between stable values representative of a stable state of the gate and values that fluctuate during the transition period.

It should be noted that the invention also applies to asynchronous electronic circuits that do not use a global clock signal to synchronize their various elements. These different elements communicate locally by indicating the sending and receiving of data, such circuits sometimes being referred to as self-sequenced circuits.

Some electronic circuits handle sensitive data that must remain confidential. The integrated circuits in bank cards or the secure elements used to manage the connection of a device that can be connected to a cellular communication network are examples of circuits that handle sensitive data. These circuits must be secured to guarantee, as far as possible, the confidentiality of the sensitive data handled. The robustness of these secure circuits is based on the use of secret data such as cryptographic keys.

Secure electronic circuits are susceptible to various kinds of attacks aimed at discovering the sensitive data handled by the circuit. Manufacturers of secure electronic circuits design countermeasures aimed at defeating these attacks.

One known attack is differential power analysis (DPA), which studies the currents and voltages entering and leaving a circuit in order to discover secret information such as the encryption key. Some operations, which are more expensive, increase the power consumption of the circuit, in particular through the use of more (analogue or logic) components. Consumption also depends on the data that are handled, for example leakage consumption depends on the datum that is retained. This analysis of variations and peaks allows valuable information to be extracted for the cryptanalyst.

Differential power analysis involves measuring the current drawn by an electronic circuit in order to use it to deduce the operations performed. Each operation performed by an electronic circuit uses a certain number of logic gates. At any given moment, the measurement of the current drawn can reflect the activity of the circuit. Of course, the currents drawn are very low, and their variations are tiny and extremely fast. Nevertheless, measuring instruments used today allow extremely fine measurements, with sub-microamp resolutions and sampling rates up to one gigahertz. Circuit security is essentially based on time jitter, masking schemes or encryption of data in memory using known cryptographic algorithms: DES, 3-DES, RSA and many more.

Fine analysis of the power consumption during computation operations makes it possible to identify differences between valid and invalid keys, and sometimes to retrieve the secret key hidden in the bowels of the device. The key is a datum that is handled by the circuit, and its value trades on the consumption of the circuit.

Due to the very large number of logic gates integrated in the circuit, the speed of operation of the circuit and the fineness of etching that introduces coupling effects between the conductive elements of the circuit, current draw measurements are affected by a high level of noise. Each measurement produces a trace that corresponds to the change, measured over time, in the power consumption. Taking advantage of these measurements requires a large number of measurements to be carried out in order to obtain a large number of corresponding traces that undergo a statistical analysis to distinguish the useful signal from the noise in which it is embedded.

The present invention aims to solve this problem by proposing a circuit architecture that makes an attack by analysis of the power consumption of the circuit impossible, or at least extremely difficult.

### SUMMARY OF THE INVENTION

To this end, the invention proposes grouping all or some of the logic gates of the circuit into groups. The circuit has at least two different voltages. Each group of logic gates can be supplied with one of the available voltages. The voltage applied to a group of gates is selected using a control signal. In one embodiment, all available voltages can be selected for each group of logic gates. In other embodiments, the set of available voltages is not systematically selectable for all of the groups of logic gates. In these embodiments, each group of logic gates can be supplied with a voltage selected from a subset of all available voltages, this subset comprising at least two available voltages.

This selection is random and is regularly changed. Thus, the electromagnetic profile of the circuit is changed at random for each use of the circuit. The consumption of each group depends on the voltage selected to supply it with. The voltage applied to the group influences the transition time of the logic gates and also the coupling effects between the metal conductors in the circuit. Accordingly, noise affecting voltage measurement is also changed at random by the selection of the voltages supplied to the groups of gates. Thus, the different traces obtained by an attacker by measuring the consumption of the circuit differ randomly both in terms of the consumption measurements and in terms of the noise affecting these measurements, making it, if not impossible, at least extremely complex to correlate these traces to obtain usable information about the sensitive data processed by the circuit.

Thus, an electronic circuit consisting of a plurality of logic gates is proposed, characterized in that:
at least a portion of the plurality of logic gates is divided into a plurality of groups
each group of logic gates is supplied with a voltage randomly selected from a set of at least two available voltages; and
a new random selection of the voltages supplied to the groups of logic gates is made between two uses of the circuit.

In some embodiments, the plurality of logic gates forming function blocks, at least one function block consists of at least two groups of logic gates.

In some embodiments, every function block consists of at least two groups of logic gates.

In some embodiments, some function blocks handling sensitive data, at least one function block that handles sensitive data consists of at least two groups of logic gates.

In some embodiments, every function block that handles sensitive data consists of at least two groups of logic gates.

In some embodiments:
the circuit comprises at least one voltage regulator responsible for generating all available voltages from an overall supply voltage for the circuit; and
the at least one regulator forces a circuit reset if the overall supply voltage does not allow all available voltages to be generated.

### BRIEF DESCRIPTION OF THE DRAWINGS

Other features, details and advantages of the invention will become apparent upon reading the detailed description below. Said description is purely illustrative and should be read with reference to the appended drawings, in which:

FIG. 1 illustrates the block operating diagram for an exemplary embodiment of the invention.

### DETAILED DESCRIPTION

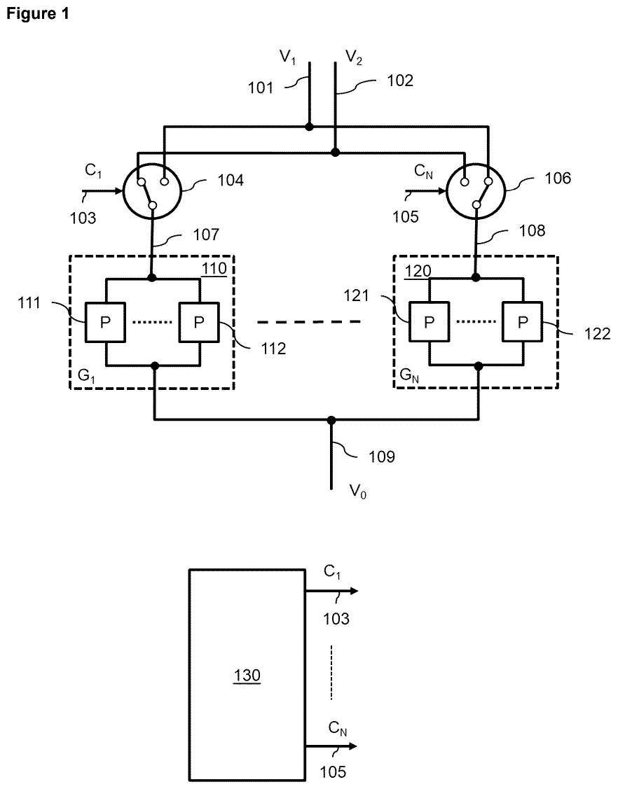

FIG. 1 illustrates the block operating diagram for an exemplary embodiment of the invention.

The circuit is broken down into N groups of logic gates, N being an integer strictly greater than 1, from group G₁ 110 to group G_{N} 120. Each group of logic gates comprises any number of logic gates 111, 112, 121, 122. It should be noted here that the logic gates that form the circuit, in their entirety, do not necessarily belong to a group of logic gates within the meaning of the solution described here. Certain parts of the circuit, typically non-sensitive parts that do not handle sensitive data, can be excluded from the division into groups of logic gates.

Each group of logic gates is connected to the zero voltage V₀ 109, which is also called the earth of the circuit. Each group of logic gates is supplied with a supply voltage 107, 108.

The circuit has at least two available supply voltages, here V₁ 101 and V₂ 102. Voltages V₁ and V₂ are different. The diagram is produced with two different voltages for reasons of clarity, but in practice a greater number of voltages can advantageously be used.

The supply voltage for each group of logic gates is determined using a controllable selector 104, 106. Each selector has its input connected to at least two of the available supply voltages 101, 102 and its output connected to the power supply of the group of logic gates 107, 108. The position of the selector and therefore the available supply voltage actually supplied to the group of logic gates is controlled by a control signal C₁, C_{N}, 103, 105.

The control signals are generated using a voltage management module 130. This voltage management module 130 randomly generates the N control signals 103 to 105. This random generation must be of the non-predictable kind, that is to say the random signal sequence generated must be different for each draw. In particular, after each power-up of the circuit, the sequence generated must be different to prevent an attacker from obtaining the same configuration each time by cutting the power to the circuit between each measurement.

The voltage management module 130 is called upon, when the circuit is powered up, to generate a random configuration of voltages. This may be sufficient for components that are typically supplied with power for each use, the power being cut between two uses. However, in order to guard against an attacker who would take care never to cut the power to the circuit under attack, it is advantageous to regularly call upon the voltage management module 130 again. For example, the most sensitive function blocks, those that handle sensitive data, can be paired with the voltage management module 130 to trigger the generation of a new voltage configuration, for example prior to or at the end of the execution of the function block. This ensures that each new execution of these sensitive function blocks benefits from a new voltage configuration.

Some function blocks perform cryptographic computations involving the execution of repeated processing loops, sometimes called rounds. In some embodiments, a new voltage configuration is generated between each execution of the loop by the function block.

In general, the generation of a new voltage configuration can be triggered by the software executed by the circuit. It is then up to the software designer to include this trigger in the appropriate places in their code. The trigger can also be introduced within a functional group, at the beginning of its execution, at the end of its execution, or within its execution, for example within a round executed in a loop by the function block.

In regard to the breakdown of the logic gates of the circuit into groups, it should be noted that the introduction of at least two groups of logic gates and two supply voltages already makes it possible to obtain four voltage configurations. Thus, if a number T of traces were necessary to obtain sensitive information from the circuit without the invention, it is necessary to obtain four times more to generate T traces for each configuration and obtain the sensitive information.

However, four-fold multiplication of the number of traces that must be obtained to break the security of the circuit may not be considered sufficient and a larger number of groups and/or available supply voltages is advantageous. It should be noted that the number of voltage configurations and therefore traces required in order to attack the circuit increases exponentially with the number of groups of logic gates and the number of available supply voltages. Advantageously, a number of groups substantially greater than two is used.

It should also be considered that the hardware resources devoted to the countermeasure also increase with the number of groups and the number of supply voltages used. Each group requires a controllable voltage selector to which each available supply voltage and a control signal must be connected. Similarly, the voltage management module 130 must generate one control signal per selector. These hardware resources form part of the circuit and compete with the useful hardware resources of the circuit. As a result, the number of groups used must remain reasonable; typically, the hardware resources devoted to the proposed solution must not require an excessively large percentage of the capabilities of the circuit.

The size of the groups in relation to the size of the function blocks is also a criterion that can be taken into account for determining the number of groups. A function block is a set of logic gates performing a particular function. In this respect, a function block is a set of logic gates that has one or more memories such as registers of the circuit or Muller gates as input and output. A register can contain one or more bits. A function block does not comprise any memory other than its inputs/outputs.

Some of these function blocks are considered sensitive because they handle sensitive data stored in the circuit. It is these function blocks that are particularly targeted by attacks and whose operation is the prime target of the attack. It may therefore be particularly advantageous for the function blocks of the circuit, considered individually, to be able to operate according to various voltage configurations. To do this, advantageously, groups whose size is smaller than the size of the function blocks will be selected. A corresponding criterion can be taken into account when the circuit is divided into groups of logic gates. This criterion is that the group of logic gates, unlike the function block, comprises inputs and/or outputs that are not memories such as registers of the circuit or Muller gates. Thus, every function block of the circuit benefits from a variety of voltage configurations.

Alternatively, the sensitive function blocks are identified and only these sensitive function blocks are subject to the constraint of consisting of at least two groups of logic gates.

In regard to the choice of available voltages that can be supplied to the different groups of logic gates of the circuit, certain constraints apply. This is because it is necessary to preserve the functionality of the group of logic gates. The circuit is assumed to operate at a nominal voltage, for example a voltage of 1 V. However, the circuits have a tolerance on the supply voltage and remain functional within a voltage range centred on this nominal voltage. The voltage margin allowing a circuit to operate is typically in the order of 10 to 15% with current technologies. This means that the circuit remains functional when supplied with a voltage between the nominal value minus 10% and the nominal value plus 10%.

In one exemplary embodiment, the nominal voltage of the circuit being 1 V, there are three available supply voltages, having the following values: 0.9 V, 1 V and 1.1 V.

The entire circuit is supplied with an overall supply voltage from which the available supply voltages for the solution described are generated. In the absence of a specific arrangement such as charge pumps, the overall supply voltage must be at least equal to the highest available supply voltage to allow all available supply voltages to be generated. In our example, the circuit must be supplied with an overall supply of at least 1.1 V in order to allow the available supply voltages of 0.9, 1 and 1.1 V to be generated.

An attacker could be tempted to limit the overall supply voltage to limit the number of available voltages and thereby the number of voltage configurations that the circuit can use. For example, if the overall supply voltage for the circuit is 0.95 V, only the voltage 0.9 V is actually available and a single voltage configuration is operational, the one where all groups are supplied with 0.9 V.

One option is for the circuit to test the value of this overall supply voltage and prohibit operation of the circuit if the overall supply voltage is not at least equal to the highest available supply voltage. For example, a circuit reset is forced when the overall supply voltage is too low.

One option is to use one or more voltage regulators in the circuit. A voltage regulator takes the overall supply voltage for the circuit and produces a regulated output voltage at a set value. From the regulated output, it is possible to generate multiple offset voltages using a resistor network. It is therefore possible to use a single voltage regulator to generate the set of available voltages. It is also possible to use one voltage regulator per available voltage. Between these two solutions, all intermediate solutions are possible. Thus, the set of available voltages is generated using one or more voltage regulators. Protection on these regulators can be provided to ensure that the available voltages can actually be generated from the overall supply voltage.

Thus, courtesy of the solution described, an attack by analysis of the consumption of the circuit is made much more difficult.

Analysis of the consumption of a circuit requires the recording of a large quantity of traces that will then be averaged to draw out the signal from the noise. However, each use of the circuit results in the consumption due to a different combination of voltages being able to be observed, said combination being difficult to compare with the previous one. For a set of m different voltages and n different groups with a uniform distribution for the selection signals, an attacker must collect a number of traces multiplied by a factor in the order of mⁿ, the standard deviation of the probabilistic distribution of the voltage combinations, in order to hope to observe all possible combinations.

To process the traces, the attacker can try to distinguish the traces using combinations of voltage values by means of an additional study that is considered relatively complex. If the traces are not distinguished using a prior study, the disparity in the transition times between the recorded traces leads to temporal smoothing of the transitions for the average traces. Additional uncertainty is therefore introduced. This is because consumptions due to successive close transitions spread out over time and overlap for the average traces. A time jitter with lower granularity than that of a clock cycle is introduced.

Naturally, in order to meet specific needs, a person skilled in the field of the invention will be able to make changes to the above description.

Although the present invention has been described above with reference to specific embodiments, the present invention is not limited to these specific embodiments, and modifications that fall within the field of application of the present invention will be obvious to a person skilled in the art.

1. An electronic circuit consisting of:
a plurality of logic gates, wherein
at least a portion of the plurality of logic gates is divided into a plurality of groups of logic gates,
each group of logic gates is supplied with a voltage randomly selected from a set of at least two available voltages, and
a new random selection of the voltages supplied to the groups of logic gates is made between two uses of the electronic circuit.

2. The electronic circuit according to claim 1, wherein the plurality of logic gates forming function blocks, at least one function block consists of at least two groups of logic gates.

3. The electronic circuit according to claim 2, wherein every function block consists of at least two groups of logic gates.

4. The electronic circuit according to claim 2, wherein some function blocks handling sensitive data, at least one function block that handles sensitive data consists of at least two groups of logic gates.

5. The electronic circuit according to claim 4, wherein every function block that handles sensitive data consists of at least two groups of logic gates.

6. The electronic circuit according to claim 1, wherein
the circuit include at least one voltage regulator responsible for generating all available voltages from an overall supply voltage for the circuit; and
the at least one regulator forces a circuit reset if the overall supply voltage does not allow all available voltages to be generated.

7. An electronic circuit, comprising:
a plurality of logic gates, wherein
at least a portion of the plurality of logic gates is divided into a plurality of groups of logic gates,
each group of logic gates is supplied with a voltage randomly selected from a set of at least two available voltages, and
a new random selection of the voltages supplied to the groups of logic gates is made between two uses of the electronic circuit.

8. The electronic circuit according to claim 7, wherein the plurality of logic gates forming function blocks, at least one function block consists of at least two groups of logic gates.

9. The electronic circuit according to claim 8, wherein every function block consists of at least two groups of logic gates.

10. The electronic circuit according to claim 8, wherein some function blocks handling sensitive data, at least one function block that handles sensitive data consists of at least two groups of logic gates.

11. The electronic circuit according to claim 10, wherein every function block that handles sensitive data consists of at least two groups of logic gates.

12. The electronic circuit according to claim 7, wherein
the circuit include at least one voltage regulator responsible for generating all available voltages from an overall supply voltage for the circuit; and
the at least one regulator forces a circuit reset if the overall supply voltage does not allow all available voltages to be generated.
